(19) United States
(12) Patent Application Publication
(10) Pub. No.: US 2008/0203083 A1
(43) Pub. Date: Aug. 28, 2008

(54) SINGLE WAFER ANNEAL PROCESSOR

(76) Inventor: Paul Z. Wirth, Columbia Falls, MT (US)

Correspondence Address: PERKINS COIE LLP/SEMITOOL, PO BOX 1208, SEATTLE, WA, 98111-1208, US

(21) Appl. No.: 11/680,393

(22) Filed: Feb. 28, 2007

(51) Int. Cl. H05B 3/22; B65G 35/00

(52) U.S. Cl. 219/411; 414/152

(57) ABSTRACT

A thermal processor is adapted for annealing substrates. The processor has a sealed process chamber. Air is excluded from the process chamber during processing to avoid oxidation of substrate surfaces, such as copper surfaces. The substrate temperature is controlled by selectively positioning the substrate between a hot plate and a cold plate operating at steady state conditions. During loading and/or unloading, the air flow is induced over the substrate. This keeps the substrate at a temperature low enough to avoid oxidation, even though the heater may remain on.

### BACKGROUND

Micro-electronic circuits and other micro-scale devices are generally manufactured from a substrate, such as a semiconductor material wafer. Multiple metal layers are applied onto the substrate to form micro-electronic components or to provide electrical connections, known as interconnects, between various devices or areas on the substrate. These metal layers are increasingly made of copper. The copper is typically plated onto the substrate, and formed into the components and interconnects, in a sequence of various photolithographic, plating, etching, polishing or other steps.

The material properties of the copper are important to the successful manufacture of semiconductor or similar devices on the substrate. These properties often change as the copper is applied to the substrate, or in related follow on steps. The material properties of the copper affect its electrical characteristics, which in turn can also affect the performance of the devices manufactured on the substrate. To achieve desired material properties, after copper is applied onto the substrate, the substrate is typically put through an annealing process. In the annealing process, the substrate is quickly heated, usually to about 200-450° C., and more typically to about 300-400° C. The substrate is held at this temperature for a relatively short time, e.g., 60-300 seconds. The substrate is then rapidly cooled, with the entire process usually taking only a few minutes. This annealing process changes the material properties of the copper on the substrate. The annealing process may similarly be used to change the properties of other materials on the substrate, or the underlying substrate material. Annealing may also be used to activate dopants, drive dopants between films on the substrate, change film-to-film or film-to-substrate interfaces, densify deposited films, or to repair damage from ion implantation.

Various annealing chambers have been proposed. In single wafer processing equipment, these annealing chambers typically position the substrate between heating and cooling elements, to control the temperature profile of the substrate. However, achieving precise and repeatable temperature profiles can present engineering challenges. An important factor in annealing substrates having copper is that copper will rapidly oxidize when exposed to oxygen, at temperatures over about 70° C. If the copper oxidizes, the substrate may no longer be useable, or the oxide layer must first be removed before further processing. These are both unacceptable options in efficient manufacturing. Accordingly, when annealing copper, another design requirement is to isolate the substrate from oxygen, when the substrate temperature is over about 70° C. Since oxygen is of course present in ambient air, avoiding oxidation of copper during annealing also can present engineering challenges.

One approach to avoiding oxidation of copper in existing annealing chambers is to provide a constant flow of purge gas, such as nitrogen, around the substrate. This approach, however, has provided only varying degrees of success. Another approach is to maintain the substrate in an inert gas filled chamber, until the substrate has cooled down to below about 70° C. However, this approach necessarily slows down the manufacturing process. Accordingly, improved annealing methods and apparatus are needed.

### SUMMARY OF THE INVENTION

The inventor has achieved substantial improvements over the foregoing processes and apparatus currently used in annealing substrates. To this end, the inventor has developed improved annealing chambers and methods that may be readily integrated into a processing system having other process chambers, including, for example, an electroplating chamber and optionally a cleaning chamber.

In one aspect, a new annealing chamber avoids thermal cycling of heating and cooling elements. The heating and cooling elements are maintained at substantially uniform temperatures. This avoids the delays associated with heat up and cool down times. The stresses and resulting premature failures from thermal cycling of these elements is also reduced or avoided. The annealing chamber may be sealed during processing. This allows for better processing performance, while consuming smaller amounts of process or purge gases. With a sealed process chamber, oxygen can more reliably be excluded from the chamber, to reduce risk of oxidation of copper or other materials.

In another aspect, air flow is provided around the wafer, while the wafer is in a load/unload position within the process chamber, waiting to be picked up by a robot. Although the wafer may be adjacent to the heating element of the chamber, and exposed to oxygen in ambient air, the air flow maintains the wafer at a temperature low enough to avoid oxidation of copper or other materials on the wafer. The invention resides in the systems, sub-systems, and methods described.

### BRIEF DESCRIPTION OF THE DRAWINGS

FIG. 1 is a perspective view of an automated wafer processing system.

FIG. 2 is a plan view of the system shown in FIG. 1.

FIG. 3 is a top perspective view of a new processor which may be used in the system shown in FIGS. 1 and 2.

FIG. 4 is a bottom perspective view of the processor shown in FIG. 3.

FIG. 5 is a perspective view of the processor shown in FIG. 3, with the top cover removed.

FIG. 6 is a bottom perspective view of the processor as shown in FIG. 6.

FIG. 7 is a plan view of the processor shown in FIG. 3.

FIG. 8 is a section view taken along line 8-8 of FIG. 7.

FIG. 9 is a section view taken along line 9-9 of FIG. 7.

FIG. 10 is a section view taken along line 10-10 of FIG. 7.

### DETAILED DESCRIPTION OF THE DRAWINGS

The invention is directed to apparatus and methods for processing a workpiece, such as a semiconductor material wafer. The term workpiece, wafer, or substrate means any flat article, including semiconductor wafers and other substrates, glass, mask, and optical or memory media, MEMS substrates, or any other workpiece having, or on which, micro-electronic, micro-mechanical, micro electro-mechanical, or micro-optical devices, may be formed. References here to a substantially uniform temperature mean that the temperature does not vary by more than 10%, 20%, 30%, or 40%. References here to a vacuum mean a sufficiently low pressure to induce flow to achieve the desired purpose. The terms vertical, horizontal, up, and down are used here only to explain the designs and operations as shown in the drawings. These terms do not signify any required orientations or relationships.

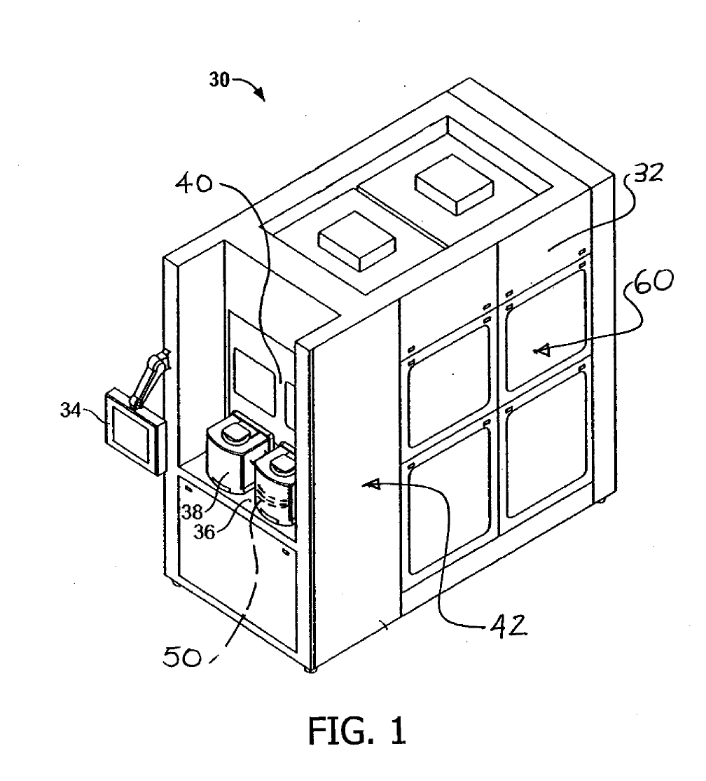

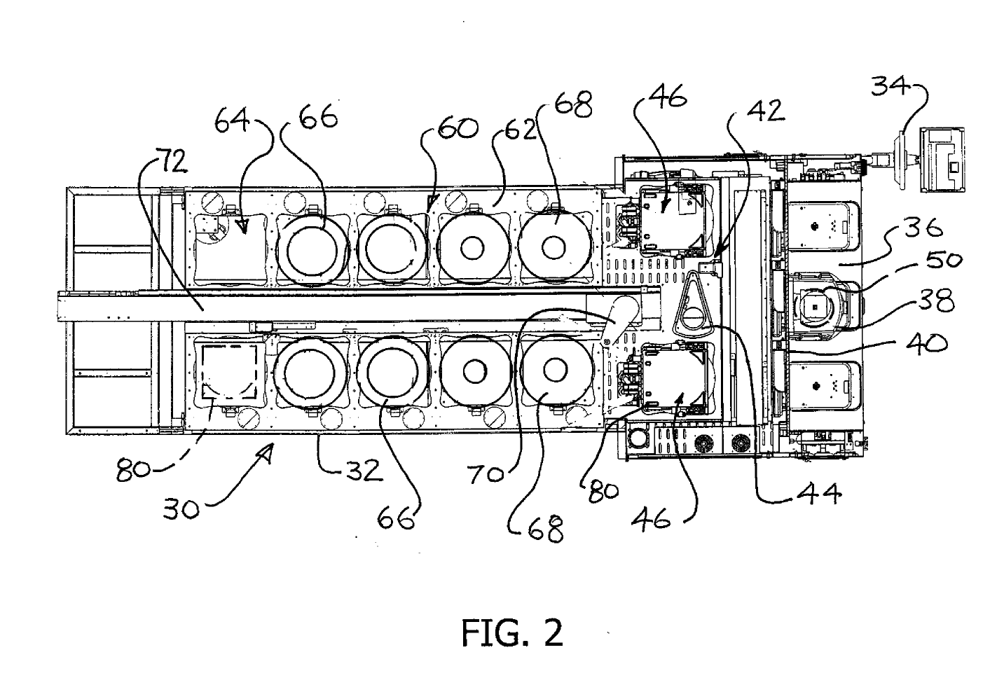

FIGS. 1 and 2 show an example of a typical automated processing system in which the anneal processor may be used. In FIGS. 1 and 2, a processing system 30 has a work in progress (WIP) section 42 and a process section 60 within an enclosure 32. A load/unload section 36 may be provided adjacent to the WIP section 42, and separated from the WIP section by a docking wall 40. Wafers 50 within containers 38 may be placed at the load/unload section 36, for movement of wafers 50 into and out of the processing system 30. Referring to FIG. 2, a WIP section robot 44 is positioned to move wafers 50 within the WIP section 42. In the automated system 30 as shown in FIGS. 1 and 2, a display/controller 34 can be used to monitor and control status and operations of the system 30.

Referring still to FIG. 2, process chambers, such as plating chambers 66, and cleaning chambers 68, are located at processor positions 64 on a deck 62 in the process section 60. A process robot 70 is moveable along a track 72 in the process section. The process robot 70 can move wafers 50 from the WIP section 42 to a process chamber 66 or 68. The process robot 70 may also move wafers 50 between process chambers. The process robot 70 generally has an end effector adapted to pick up and hold a wafer, for example, as described in U.S. patent application Ser. No. 11/480,313; U.S. Pat. Nos. 6,976,822; 6,752,584 B2; 6,749,391 B2; 6,749,390; or 6,572,320 incorporated herein by reference.

In FIG. 2, four plating chambers 66 and four cleaning chambers 68 are shown. Empty processor positions 64 are shown at the left side of the deck 62 in FIG. 2, for purpose of illustration only. In an actual system 30, these processor positions 64 would ordinarily be occupied by additional process chambers. In this example, the processing system 30 could have six plating chambers 66 and four cleaning chambers 68. Of course, more or fewer of each type of chamber 66 and 68 may be provided. Although the chambers 66 and 68 are shown in linear rows in FIG. 2, in other forms of the processing system 30, the chambers may be arranged in arcuate, round, cross-shaped, or other arrangements. The processing system 30 may also include other types of processing chambers, apart from plating and cleaning chambers 66 and 68, depending on the specific application. Various numbers and types of each of the robots 44 and 70 may also be used.

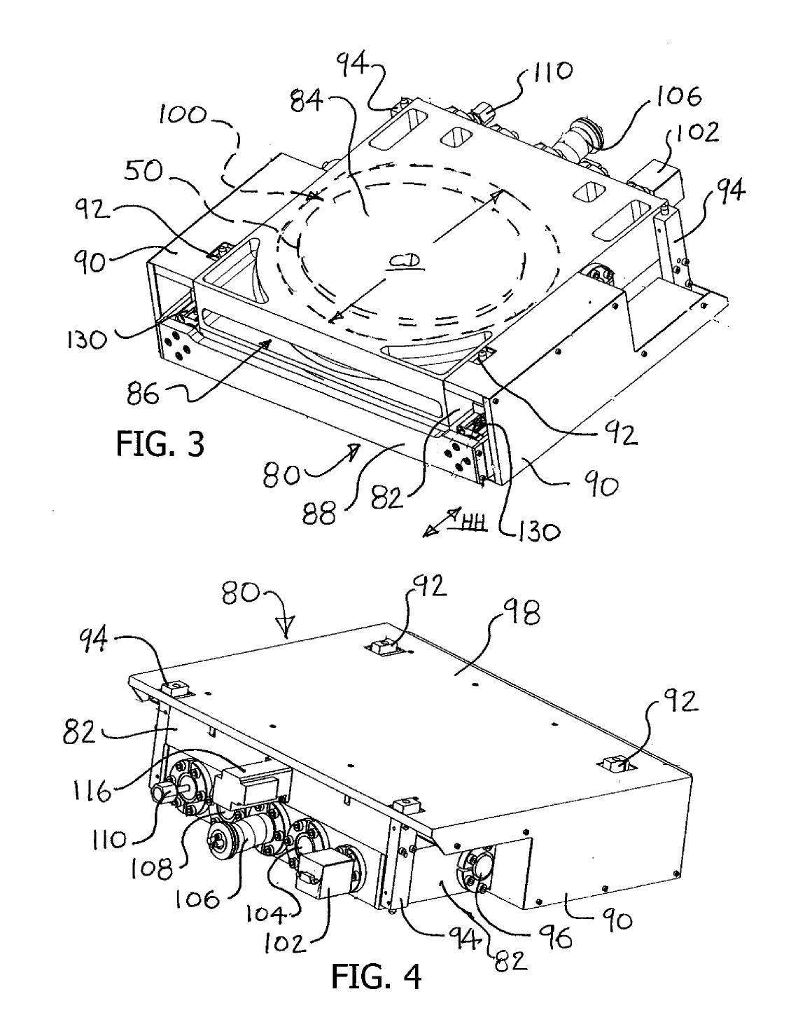

Turning now to FIGS. 3 and 4, an anneal processor 80 has a top plate 84 attached to and sealed against a base 82. A load slot 86 is provided through the top plate 84, to allow movement of a wafer 50 into and out of the anneal chamber 80. As shown in FIG. 3, a door 88 is adjacent to the load slot 86. The door 88 is shown in the open position in FIG. 3, for loading and unloading a wafer 50 into and out of the anneal processor 80. The door is moveable to close off and seal the load slot 86 during processing. The load slot 86 provides an entry way into a generally disk-shaped anneal chamber 100, shown in dotted lines in FIG. 3, in the anneal processor 80. The anneal chamber 100 may have a diameter slightly larger than the wafer 84 to be annealed. For example, with an anneal processor 80 designed for a 300 mm wafer, the chamber diameter CD in FIG. 3 may be from about 310-400, 320-380, or 330-370 mm, or generally with CD about 5-25% larger than the wafer diameter.

Referring to FIG. 4, a process gas inlet 110 extends into the anneal chamber 100, generally adjacent to the back of the chamber 100, opposite from the load slot 86. Similarly, a vacuum port 104 and a gas exhaust port 108 lead into the anneal chamber 100. FIG. 4 also shows electrical lines 106 running into the anneal processor 80, to provide power, control and signal lines. A pressure transducer 102 may also be provided, to measure gas pressure within the anneal chamber 100. Referring still to FIG. 4, one or more transparent windows 96 may be provided on the base 82, to allow visual inspection of the chamber 100.

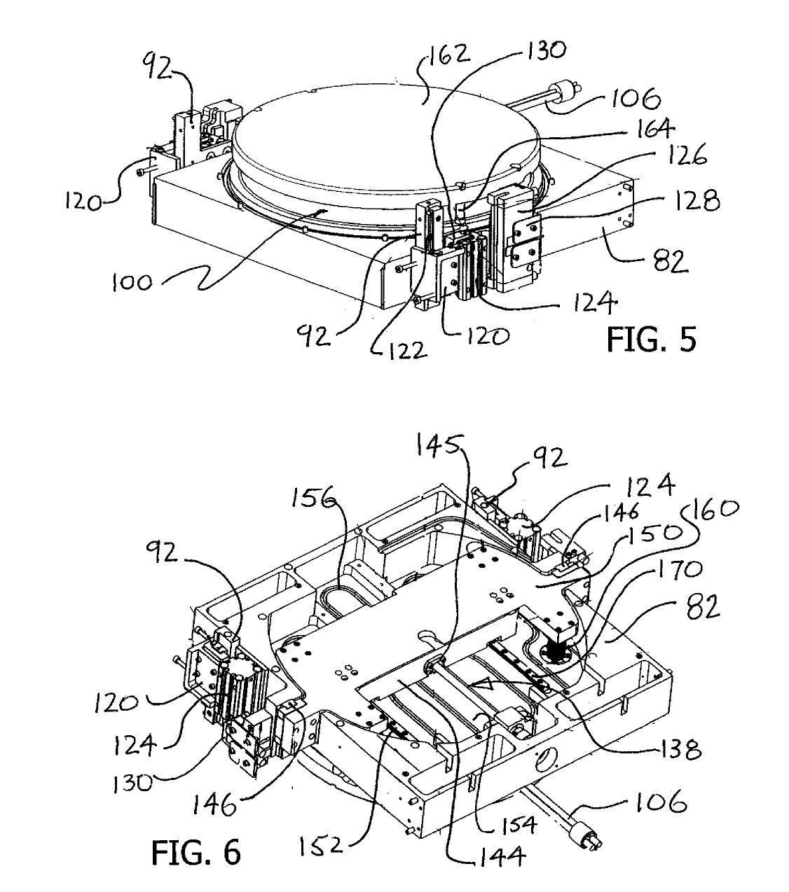

FIG. 5 shows the anneal processor 80 with the top plate 84 and other components removed. A heater 162 is supported on insulator stand-offs 164 on the base 82. A sensor 126 is attached to the base 82 via sensor clamps 128. The door 88, shown in FIG. 3, is attached to left and right brackets 120, as shown in FIG. 5. Each bracket 120 is supported on a vertical linear door guide 122, and is moveable along the guide 122 via an actuator 124, such as an air cylinder. Referring still to FIG. 5, a horizontal door actuator 130, which may also be an air cylinder, is attached to the base 82 and positioned to move the brackets 120 and the door 88 supported on the brackets 120, horizontally, in the direction HH shown in FIG. 3. Also, as shown in FIG. 3, the door guides 122, actuators 124 and 130 on each side of the base 82, and the sensor 126, are covered by side covers 90 attached to the base 82.

As shown in FIGS. 3 and 4, front door posts 92 are attached on opposite sides of the base 82 towards the front of the anneal processor 80. Similarly, rear door posts 94 are attached to the base 82 adjacent to the rear corners of the anneal processor 80. As shown in FIG. 4, a bottom cover 98 is attached to the bottom of the base 82. The door posts 92 and 94 extend down through openings in the bottom cover 98.

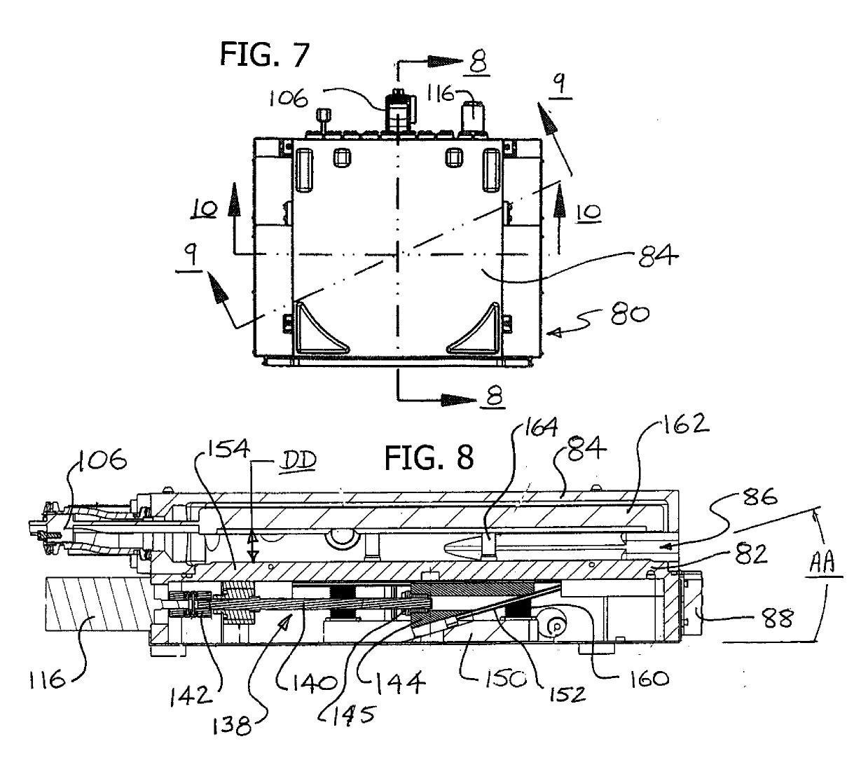

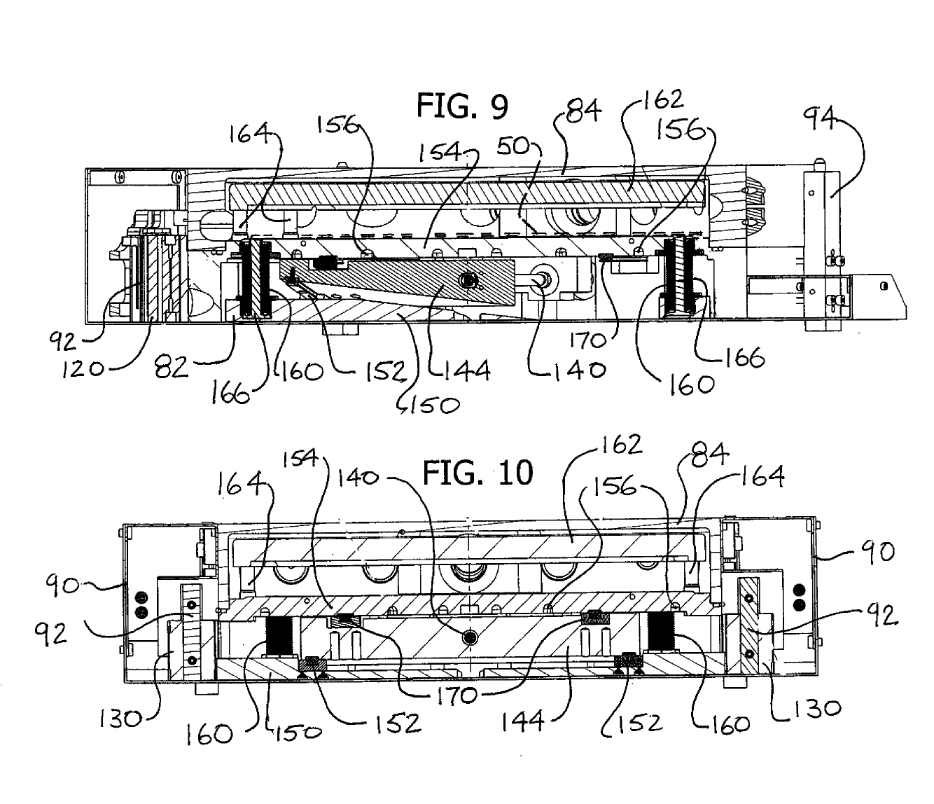

Turning now to FIG. 6, a pin plate 150 is attached to vertical linear guides 146 on the base 82, so that the pin plate 150 can only move vertically. Turning now also to FIGS. 7-10, pins 166 are attached to, and extend upwardly from the pin plate 150. In the specific design shown, four pins are substantially equally spaced apart on a circle. As shown in FIG. 9, the pins 166 extend up through openings in a cold plate 154 formed in the base 82. As shown in FIGS. 6, 9, and 10, each of the pins 166 is surrounded by a bellows 160. The top end of each bellows 160 is sealed to the bottom surface of the cold plate 154. The bottom end of each bellows 160 is sealed onto the top surface of the pin plate 150. As shown in FIGS. 6, 9, and 10, cooling coils 156 are formed in, or otherwise provided on, the cold plate 154. As shown in FIG. 8, the spacing DD between the cold plate 154 and the heater 162 is about 10-40 or 20-30 mm. The heater and the cold plate have flat and parallel surfaces facing each other, and they may have the same diameter.

Referring to FIGS. 3, 6, and 8, a pin plate drive system 138 includes a motor 116 attached to a ball screw 140 through a coupler 142. The follower 145 of the ball screw 140 is attached to an angle plate 144. As shown in FIGS. 6, 9, and 10, the top of the angle plate 144 is attached to the bottom surface of the cold plate 154 on angle plate linear guides 170. The angle plate 170 can accordingly only move horizontally (left/right in FIG. 8). As shown in FIGS. 8-10, the top surface of the pin plate 150 is attached to the bottom surface of the angle plate 144 via pin plate linear guides 152. As shown in FIG. 8, the pin plate linear guides 152 extend upwardly at an angle AA of about 10-30 or 15-25 degrees. Consequently, as shown in FIGS. 8 and 9, as the pin plate drive system 138 pulls the angle plate 144 outwardly (to the left side in FIG. 8), the pin plate 150 moves up, causing the pins 166 to extend up through the cold plate 154. Conversely, when the pin plate drive system 138 moves the angle plate 144 outwardly (to the right side in FIG. 8), the pin plate 150 moves down, causing the pins 166 to move to a lower position, flush with, or slightly below the top surface of, the cold plate 154. The plates 150 and 144, and the drive system 138 are one example of various equivalent designs that may be used to raise and lower a wafer 50 in the anneal chamber 100.

In use, the anneal processor 80 may be used as a stand alone manually operated processor. However, more often the anneal processor 80 is included in an automated processing system, such as the processing system 30 shown in FIGS. 1 and 2. In this design, the anneal processor 80 may be installed at a processor position 64, on or above the deck 62, as shown in dotted lines in FIG. 2. Alternatively, one or more anneal processors 80 may be provided in the WIP section 42. Several of the anneal processors 80 may be assembled into a vertically stacked array 46 of anneal processors 46, as shown in FIG. 2. In this way, multiple anneal processors 80 may be installed within a relatively compact space. The door posts 92 and 94 may include alignment pins or other mounting and attaching features, for assembling the processors 80 into vertically stacked arrays 46.

Referring to FIGS. 1 and 2, in a typical manufacturing operation, wafers 50 are delivered to the load/unload section 36 of the processing system 30 within containers 38. The containers 38 are optionally docked, or engaged against, the docking wall 40, and the container door, if any, is released and removed from the container 38. The WIP section robot 44 extends an end effector through an opening in the docking wall 40 and into the container 38, to pick up a wafer 50. The robot 44 then moves the wafer 50 into the WIP section 42. The process robot 70 picks up the wafer and moves it into a plating chamber 66, where a metal film, such as copper, is applied to the wafer 50.

After completion of the plating process, the process robot 70 returns to the plating chamber 66, picks up the wafer 50, and moves the wafer 50 into a clean chamber 68, where contaminants are removed from the wafer 50 (most often from the back side, edge, and a narrow annular area on the front side extending a few millimeters inwardly from the edge). The process robot 70 then returns to the clean chamber 68 and moves the now metal plated and cleaned wafer to a temporary storage position within the WIP section 42.

The WIP robot 44 picks up the wafer 50 and moves it into an anneal processor 80, through the load slot 86. The pin plate 150 is in the down position, so that the pins 166 do not interfere with movement of the wafer 50 into the anneal chamber 100. The robot 44 lowers the wafer 50 down onto the top surface of the cold plate 154, and then withdraws. Alternatively, the pin plate 150 may be in a position where the pins 166 extend just slightly above the top surface of the cold plate 154, so that the wafer 50 is supported on the pins 166, rather than on the cold plate 154.

The heater 162 generally remains on constantly during processing operations, regardless of whether a wafer 50 is in the processor 80. Accordingly, the heater 162 generally remains at a substantially uniform or steady state temperature. The heater temperature 162 may vary depending on the specific annealing process to be performed. Typical heater temperatures range from about 300 to 550° C. Since thermal cycling of the heater 162, with processing of each wafer 50, is avoided, the stresses and related potential heater failures are reduced or avoided. The cold plate 154 is similarly maintained at a substantially uniform cold temperature, typically from about 10-20° C. Chilled water may be circulated through the cooling coils 156 to maintain the cold plate 154 at a desired cold temperature.

With the wafer 50 within the processor 80, the vertical door actuators 124 raise the door from the open position shown in FIGS. 3 and 8, to a closed position, where the door 88 is aligned with the load slot 86. The horizontal door actuators 130 then pull the door 88 inwardly, causing the door 88 to seal around the load slot 86. The anneal chamber 100 is then sealed.

Various annealing processes may then be performed. In a typical anneal process, the anneal chamber 100 is initially evacuated by pumping the ambient air in the chamber 100 out via the vacuum port 104. The chamber 100 may then be back filled with a process gas by supplying the process gas in through the process gas inlet 110. The evacuation or pump down step followed by back filling with process gas steps may be repeated, to minimize the presence of any remaining ambient air in the chamber 100. In the evacuation step, the chamber 100 may typically be pumped down to a pressure of a few torr. The process gas back filled into the chamber 100 is typically helium or hydrogen, although other gases may also be used. The gas pressure in the chamber 100 may be adjusted to above or below ambient pressure. Since the wafer 50 is on, or close to, the cold plate 154, the wafer 50 remains relatively cool during the loading, evacuation, and process gas back filling steps, even though the heater 162 may be at a high temperature.

With the chamber 100 sealed and substantially devoid of any oxygen (e.g., 1 ppm or less), the motor 116 is turned on to actuate the pin plate drive system 138. Specifically, the motor 116 drives the ball screw 140 pulling the angle plate 144 inwardly (towards the left in FIG. 8). This movement drives the pin plate 150 up. The pins 166 on the pin plate 150 move up through the cold plate 154, lifting the wafer 50 and moving the wafer 50 closer to the heater 162. In a typical design, with the heater 162 at 400° C., and the cold plate at about 10° C. and spaced apart from the heater 162 by about 25 mm, small vertical movements of the wafer 50 towards the heater 162 result in relatively large wafer temperature changes.

The heater 162 is generally electrically powered via electric power lines 106. Thermocouple lines may also be used to measure temperatures in the chamber.

The wafer 50 is held at an intermediate position between the heater 162 and the cold plate 154, to achieve a desired wafer temperature, for a desired time interval. The wafer 50 is then lowered back towards or onto the cold plate 154 by reversing the motor 116. The process gas may optionally then be evacuated from the chamber 100 via the gas exhaust line 108. Pressure within the chamber 100 may be monitored by the pressure transducer 102. The chamber 100 is then unsealed by opening the door 88, by reversing the movement of the door actuators 130 and 124.

With the chamber 100 unsealed, ambient air containing oxygen enters into the chamber 100. As the wafer 50 is on or close to the cold plate 154, the wafer 50 remains relatively cool, even though the heater 162 remains at its operating temperature of several hundred degrees C. Consequently, metal, specifically copper, on the wafer 50 is not oxidized via the ambient air entering into the chamber 100.

Since the wafer 50 must typically be handled by the end effector only at the edges, the wafer 50 must be raised up off of the cold plate 154 for unloading. However, raising the wafer 50 up off of the cold plate 154 causes the wafer temperature to increase significantly. Since during the unloading sequence, the chamber 100 is filled with ambient air, excessive wafer temperatures will result in oxidation of copper (or other materials) on the wafer 50. To limit the wafer temperature during the unloading sequence, when the wafer is lifted up off of the cold plate 154, a flow of air across the wafer 50 is induced by drawing air out of the back of the chamber 100 through the vacuum port 104 and/or the gas exhaust 108. Under these conditions, the flow of air maintains the wafer temperature below 70° C., thereby avoiding risk of oxidation on the wafer 50. For a 300 mm wafer processor, having a chamber volume of about 2.5 to 5 liters (150-300 cubic inches), a flow rate of room temperature air through the chamber of about 300-600 liters per minute (10.6-21.2 cfm) or 400-500 liters per minute (14.1-17.7 cfm) generally provides sufficient cooling to keep the wafer temperature below 70° C. Alternatively, providing room temperature air flow over the wafer at about 300-500 meters per minute (975-1625 feet per minute) similarly provides substantially equivalent cooling.

### EXAMPLE 1

A processor 80 as described above was operated with the heater 162 at 275° C. The cold plate 154 was kept at 15° C. The wafer was lifted up 9.5 mm above the cold plate. This placed the wafer 16 mm from the heater 162. Air flow at a rate of 445 liters per minute (15 cfm) was induced across the wafer via an air amplifier attached to an exhaust outlet at the back of the chamber. Air flow volume was calculated from measured air speed, using a hot wire anemometer to measure air speed. A nine point thermocouple 300 mm sensarray wafer was used to measure the wafer temperature. The measured air speed was 427 meters per minute (1400 feet per minute), as measured at the center of a 35 mm (1.375 inch) ID exhaust pipe.

The wafer temperature ranged from 31° C. to 41° C., with the wafer cooler towards the front opening of the chamber. The maximum wafer temperature stabilized at 41° C.

### EXAMPLE 2

The conditions of Example 1 above were repeated, but with the heater at 400° C. The wafer temperature ranged from 43° C. to 57° C., again with the wafer temperature cooler towards the front opening of the chamber. The maximum wafer temperature stabilized at 57° C.

Thus, novel apparatus and methods have been shown and described. Various changes and substitutions may of course be made, without departing from the spirit and scope of the invention. The invention, therefore, should not be limited except by the following claims and their equivalents.

1. A thermal processor, comprising:
a housing forming a process chamber;
an opening through the housing leading to the process chamber;
a door moveable to a closed position, where the door closes off the opening and seals the process chamber, and to an open position where the door is moved away from the opening;
a hot plate in the process chamber;
a cold plate in the process chamber, spaced apart from the hot plate;
one or more wafer supports extendable through the cold plate.

2. The thermal processor of claim 1 with the process chamber having a top and a bottom, and with the cold plate adjacent to the bottom of the process chamber, and with the hot plate adjacent to the top of the process chamber.

3. The thermal processor of claim 1 with the wafer supports extendable substantially perpendicularly out of the cold plate and towards the hot plate.

4. The thermal processor of claim 1 with the process chamber forming a disk-shaped space between the cold plate and the hot plate.

5. The thermal processor of claim 4 with the process chamber having a diameter 5-25% greater than the diameter of the wafer, and with the hot plate spaced apart from the cold plate by 15-25 mm.

6. The thermal processor of claim 1 with the pins attached to a pin plate and further comprising an angle plate moveable parallel to the plane of the pin plate, and with linear movement of the angle plate in one direction moving the pins towards the hot plate, and with linear movement of the angle plate in an opposite direction moving the pins away from the hot plate.

7. The thermal processor of claim 6 further comprising a linear actuator attached to the angle plate for moving the angle plate relative to the pin plate.

8. The thermal processor of claim 1 further comprising a vacuum port connecting into the process chamber at a position generally opposite from the door.

9. A method for thermally processing a wafer, comprising:
moving a wafer into a process chamber;
sealing the process chamber;
removing ambient air from the process chamber;
providing a process gas into the process chamber;
heating the wafer and then cooling the wafer by changing the position of the wafer relative to heating and cooling elements;
unsealing the process chamber;
moving the wafer into a unload position in the process chamber for pick up by a robot; and
flowing air over the wafer while the wafer is in the unload position.

10. The method of claim 9 further comprising maintaining the heating element at a substantially constant temperature.

11. A method for thermally processing a wafer, comprising:
maintaining a heater in a process chamber at a substantially uniform first temperature;
maintaining a cooler in the process chamber at a substantially uniform second temperature;
moving a wafer into a process chamber via a robot;
setting the wafer down onto pins in the process chamber;
sealing the process chamber;
removing ambient gas from the process chamber by applying a vacuum to the process chamber;
providing a process gas into the process chamber;
heating the wafer by lifting the wafer on the pins toward the heater, to a first position in the process chamber;
cooling the wafer by lowering the wafer on the pins towards the cooler, to a second position in the process chamber;
unsealing the process chamber;
lifting the wafer into a robot access position in the process chamber for pick up by a robot, with the robot access position between the first position and the second position; and
flowing air over the wafer while the wafer is in the robot access position, to maintain the wafer temperature below a specified temperature.

12. A processing system comprising:
a load/unload section;
a work-in-progress section adjacent to the load/unload section;
at least one robot moveable in the load/unload section and the work-in-progress section;
a process section adjacent to the work-in-progress station, with the process station including at least one electro-chemical processor;
at least one process robot moveable in the process section and the work-in-progress section;
at least one thermal processor in the process section or in the work-in-progress section, with the thermal processor comprising:
a housing forming a process chamber;
an opening through the housing leading to the process chamber;
a door moveable to a closed position, where the door closes off the opening and seals the process chamber, and to an open position where the door is moved away from the opening;
a hot plate in the process chamber;
a cold plate in the process chamber, spaced apart from the hot plate;
one or more wafer supports extendable through the cold plate.

13. The system of claim 12 further comprising means for maintaining the temperature of a wafer below a specified temperature, while the wafer is on the wafer supports and in a position between the cold plate and the hot plate, for pick up by the process robot.

14. The system of claim 12 further comprising a vacuum source connectable into the process chamber to draw air over a wafer in the process chamber, while the wafer is on the wafer supports and in a position between the cold plate and the hot plate, for pick up by the process robot.

15. A thermal anneal chamber, comprising:
a process chamber;
a wafer load opening in the process chamber;
door means for providing an opening into the chamber during wafer loading and unloading, and for sealing the chamber during processing;
cooling means at a first side of the process chamber;
heating means at a second side of the process chamber;
support means for supporting a wafer in the process chamber;
drive means linked to the support means for moving a wafer in the process chamber closer to the cooling means or the heating means; and
means for inducing air flow through the process chamber during wafer loading or unloading.

16. The thermal anneal chamber of claim 15 with the heating means comprising a plate heater, and the cooling means comprising a fluid cooled cold plate fixed in position relative to the plate heater.

17. The thermal anneal chamber of claim 16 with the support means comprising pins on a pin plate moveable relative to the cold plate, and with the pins extending through the cold plate.

18. The thermal anneal chamber of claim 17 with the drive means including an linear actuator attached to an angle plate engaged to the pin plate.

19. The thermal anneal chamber of claim 17 further comprising a bellows around each of the pins, and with the bellow sealed against the pin plate and the cold plate.

20. The thermal anneal chamber of claim 17 with the pin plate supported on linear guides extending an acute angle to the plane of the cold plate.
